(19) United States
(12) Patent Application Publication
(10) Pub. No.: US 2006/0020878 A1
(43) Pub. Date: Jan. 26, 2006

(54) System and method for efficiently performing manual frame transfers of image data

(76) Inventor: Juraj Bystricky, Richmond (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/896,799

(22) Filed: Jul. 22, 2004

(51) Int. Cl. G06F 15/00; G06F 17/21

(52) U.S. Cl. 715/500; 712/220

(57) ABSTRACT

A system and method for performing manual frame transfers of image data includes an electronic device with a central processing unit, a display device, and a display controller. The display controller includes controller logic that toggles a transfer flag in response to a transfer trigger event in the display controller for initiating a manual frame transfer operation to transfer on-screen data from a video memory of the display controller to the display device. In certain embodiments, the transfer trigger event may be generated by either a write counter or a transfer timer. The central processing unit responsively coordinates the manual frame transfer operation to transfer the on-screen data from the video memory to the display device of the host electronic device.

### BACKGROUND SECTION

1. Field of Invention

This invention relates generally to electronic display controller systems, and relates more particularly to a system and method for efficiently performing manual frame transfers of image data.

2. Description of the Background Art

Implementing efficient methods for displaying electronic image data is a significant consideration for designers and manufacturers of contemporary electronic devices. However, efficiently displaying image data with electronic devices may create substantial challenges for system designers. For example, enhanced demands for increased device functionality and performance may require more system operating power and require additional hardware resources. An increase in power or hardware requirements may also result in a corresponding detrimental economic impact due to increased production costs and operational inefficiencies.

Furthermore, enhanced device capability to perform various advanced display control operations may provide additional benefits to a system user, but may also place increased demands on the control and management of various device components. For example, an enhanced electronic device that efficiently manipulates, transfers, and displays digital image data may benefit from an efficient implementation because of the large amount and complexity of the digital data involved.

Due to growing demands on system resources and substantially increasing data magnitudes, it is apparent that developing new techniques for controlling the display of electronic image data is a matter of concern for related electronic technologies. Therefore, for all the foregoing reasons, developing efficient systems for displaying electronic image data remains a significant consideration for designers, manufacturers, and users of contemporary electronic devices.

### SUMMARY

In accordance with the present invention, a system and method are disclosed for efficiently performing manual frame transfers of image data. In certain embodiments, an electronic device may be implemented to include a central-processing unit (CPU), a display, and a display controller. Controller logic of the display controller toggles a transfer flag in response to any appropriate transfer trigger event. For example, a transfer timer may cause the controller logic to toggle the transfer flag after a pre-determined transfer interval has been exceeded, or the controller logic may detect that a total written pixel value from a write counter has exceeded a pre-determined write-operation pixel threshold.

If the controller logic toggles the transfer flag to signify that a transfer trigger event has occurred, then the CPU of the host electronic device may responsively coordinate a manual frame transfer operation for on-screen data in video memory of the display controller. In certain embodiments, the CPU instructs the display controller to perform the manual frame transfer operation for sending the on-screen data to the display of the host electronic device.

In response, display logic of the display stores the transferred on-screen data into a designated local storage location in a display memory. Finally, the display may display the on-screen data from the display memory on one or more screens for viewing by a device user. For at least the foregoing reasons, the present invention therefore supports manual transfer operations to efficiently provide full frames of on-screen image data to a display of a host electronic device.

### BRIEF DESCRIPTION OF THE DRAWINGS

FIG. 1 is a block diagram for one embodiment of an electronic device, in accordance with the present invention;

FIG. 2 is a block diagram for one embodiment of the display controller of FIG. 1, in accordance with the present invention;

FIG. 3 is a block diagram for one embodiment of the video memory of FIG. 2, in accordance with the present invention;

FIG. 4 is a block diagram for one embodiment of the controller registers of FIG. 2, in accordance with the present invention;

FIG. 5 is a block diagram for one embodiment of the display of FIG. 1, in accordance with the present invention;

FIG. 6 is a flowchart of method steps for performing a transfer cycle initialization procedure, in accordance with one embodiment of the present invention;

FIG. 7 is a flowchart of method steps for utilizing a write counter, in accordance with one embodiment of the present invention;

FIG. 8 is a flowchart of method steps for utilizing a transfer timer, in accordance with one embodiment of the present invention; and

FIG. 9 is a flowchart of method steps for performing a manual frame transfer operation, in accordance with one embodiment of the present invention.

### DETAILED DESCRIPTION

The present invention relates to an improvement in display controller systems. The following description is presented to enable one of ordinary skill in the art to make and use the invention, and is provided in the context of a patent application and its requirements. Various modifications to the embodiments disclosed herein will be apparent to those skilled in the art, and the generic principles herein may be applied to other embodiments. Thus, the present invention is not intended to be limited to the embodiments shown, but is to be accorded the widest scope consistent with the principles and features described herein.

The present invention comprises a system and method for performing manual frame transfers of image data, and includes an electronic device with a central processing unit, a display device, and a display controller. The display controller includes controller logic that toggles a transfer flag in response to a transfer trigger event in the display controller for initiating a manual frame transfer operation to transfer on-screen data from a video memory of the display controller to the display device. In certain embodiments, the transfer trigger event may be generated by either a write counter or a transfer timer. The central processing unit responsively coordinates the manual frame transfer operation to transfer the on-screen data from the video memory to the display device of the host electronic device.

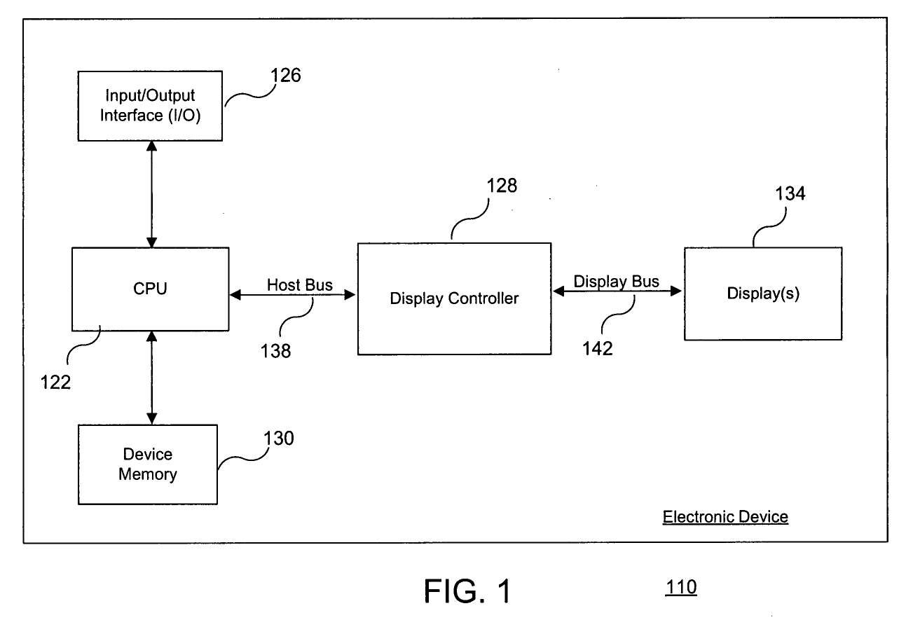

Referring now to FIG. 1, a block diagram for one embodiment of an electronic device 110 is shown, according to the present invention. The FIG. 1 embodiment includes, but is not limited to, a central processing unit (CPU) 122, an input/output interface (I/O) 126, a display controller 128, a device memory 130, and one or more display(s) 134. In alternate embodiments, electronic device 110 may include elements or functionalities in addition to, or instead of, certain of the elements or functionalities discussed in conjunction with the FIG. 1 embodiment.

In the FIG. 1 embodiment, CPU 122 may be implemented as part of appropriate managing means to include any appropriate and effective processor device, microprocessor for controlling and coordinating the operation of electronic device 110 in response to various software program instructions. In the FIG. 1 embodiment, device memory 130 may comprise any desired storage-device configurations, including, but not limited to, random access memory (RAM), read-only memory (ROM), and storage devices such as removable memory or hard disk drives. In the FIG. 1 embodiment, device memory 130 may include, but is not limited to, a device application of program instructions that are executed by CPU 122 to perform various functions and operations for electronic device 110. The particular nature and functionality of the device application typically varies depending upon factors such as the type and specific use of the corresponding electronic device 110.

In the FIG. 1 embodiment, the foregoing device application may include program instructions for allowing CPU 122 to provide image data and corresponding transfer and display information via host bus 138 to display controller 128. In accordance with the present invention, display controller 128 then responsively provides the received image data via display bus 142 to at least one of the display(s) 134 of electronic device 110. In the FIG. 1 embodiment, input/output interface (I/O) 126 may include one or more interfaces to receive and/or transmit any required types of information to or from electronic device 110. Input/output interface 126 may include one or more means for allowing a device user to communicate with electronic device 110. In addition, various external electronic devices may communicate with electronic device 110 through I/O 126. For example, a digital imaging device, such as a digital camera, may utilize input/output interface 126 to provide captured image data to electronic device 110.

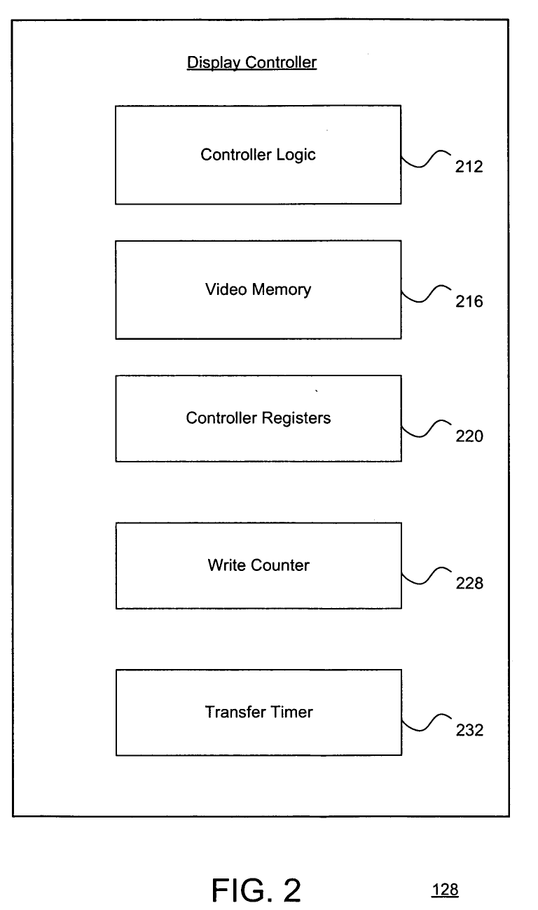

In the FIG. 1 embodiment, electronic device 110 may advantageously utilize display controller 128 for efficiently managing various operations and functionalities relating to display(s) 134. The implementation and functionality of display controller 128 is further discussed below in conjunction with FIGS. 2-4 and 6-9. In the FIG. 1 embodiment, electronic device 110 may be implemented as any desired type of electronic device or system. For example, in certain embodiments, electronic device 110 may alternately be implemented as a cellular telephone, a personal digital assistant device, an electronic imaging device, a cellular telephone, or a computer device. Various embodiments for the operation and utilization of electronic device 110 are further discussed below in conjunction with FIGS. 2-9.

Referring now to FIG. 2, a block diagram for one embodiment of the FIG. 1 display controller 128 is shown, according to the present invention. The FIG. 2 embodiment includes, but is not limited to, controller logic 212, video memory 216, controller registers 220, a write counter 228, and a transfer timer 232. In alternate embodiments, display controller 128 may include elements or functionalities in addition to, or instead of, certain of the elements or functionalities discussed in conjunction with the FIG. 2 embodiment.

In the FIG. 2 embodiment, display controller 128 may be implemented as an integrated circuit device that accepts image data and corresponding transfer and display information from CPU 122 (FIG. 1). Display controller 128 then provides the received image data to display 134 of electronic device 110 in an appropriate and efficient manner for displaying to a device user. In the FIG. 2 embodiment, controller logic 212 manages the overall operation of display controller 128. In certain embodiments, controller logic 212 may include, but is not limited to, an image creation module. The image creation module manages reading image data from video memory 216, and forming corresponding image pixels for display according to information from controller registers 220.

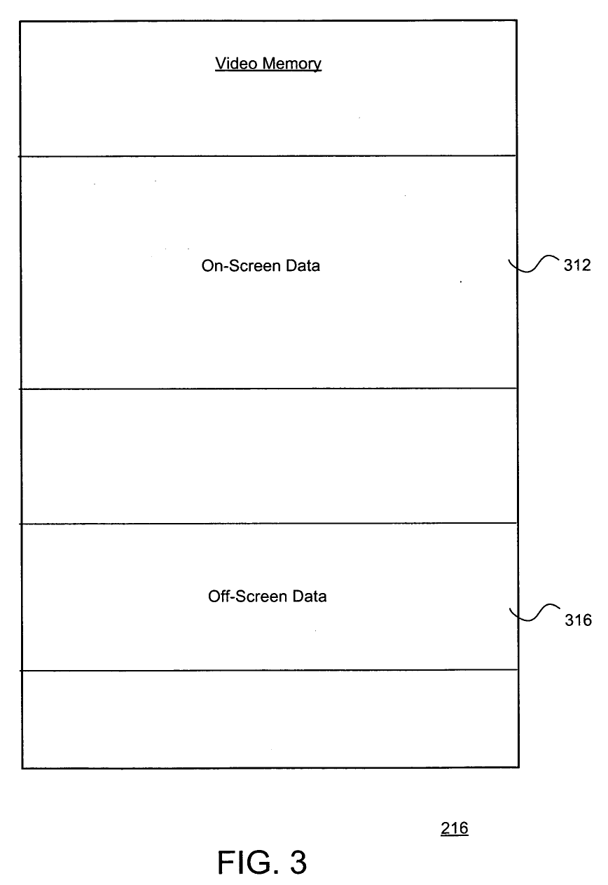

In the FIG. 2 embodiment, display controller 128 uses write counter 228 and transfer timer 232 to trigger frame transfer operations for transferring on-screen data from video memory 216 to display 134 (FIG. 1). Certain embodiments for the implementation and utilization of controller logic 212, write counter 228, and transfer timer 232 are further discussed below in conjunction with FIGS. 3-4 and 6-9.

Referring now to FIG. 3, a block diagram for one embodiment of the FIG. 2 video memory 216 is shown, in accordance with the present invention. In the FIG. 3 embodiment, video memory 216 includes, but is not limited to, on-screen data 312 and off-screen data 316. In alternate embodiments, video memory 216 may include elements and functionalities in addition to, or instead of, certain of the elements and functionalities discussed in conjunction with the FIG. 3 embodiment.

In the FIG. 3 embodiment, video memory 216 may be implemented by utilizing any effective types of memory devices or configurations. For example, in certain embodiments, video memory 216 may be implemented as a random-access memory (RAM) device. In the FIG. 3 embodiment, on-screen data 312 and off-screen data 316 are each shown as single contiguous memory blocks in video memory 216. However, in various other embodiments, different components of on-screen data 312 and/or off-screen data 316 may readily be stored as multiple non-contiguous memory blocks within video memory 216.

In the FIG. 3 embodiment, CPU 122 (FIG. 1) writes image data into on-screen data 312 for transfer by display controller 128 to display 134 of electronic device 110 for viewing by a device user. In the FIG. 3 embodiment, on-screen data 312 includes any appropriate type of information for display upon a screen of display 134 (FIG. 1). For example, on-screen data 312 may include main image data corresponding to a main window area on display 134. In addition, on-screen data 312 may include picture-in-picture (PIP) image data corresponding to one or more picture-in-picture window areas that are positioned within the foregoing main window area on display 134.

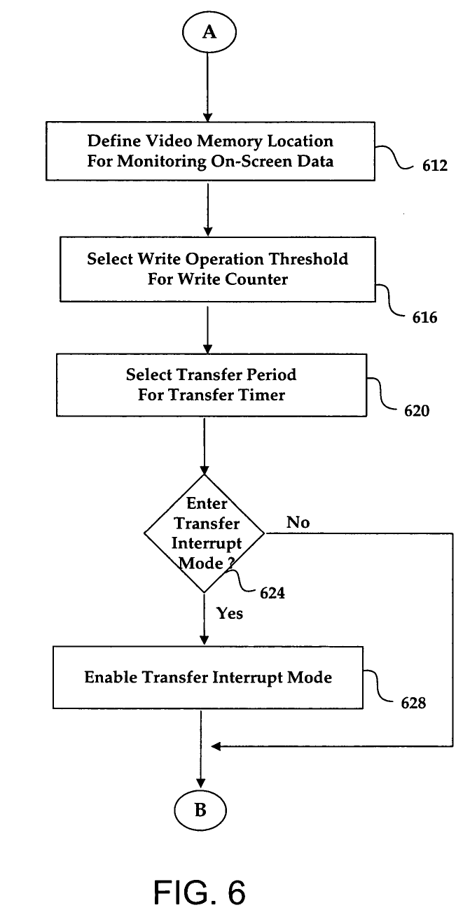

In the FIG. 3 embodiment, off-screen data 316 may include any appropriate type of information or data that is not displayed upon display 134 of electronic device 110. For example, off-screen data 316 may be utilized to support various types of double buffering schemes for display controller 128, or may also be utilized to cache certain fonts or other objects for use by display controller 128. The utilization of video memory 216 is further discussed below in conjunction with FIGS. 6-9.

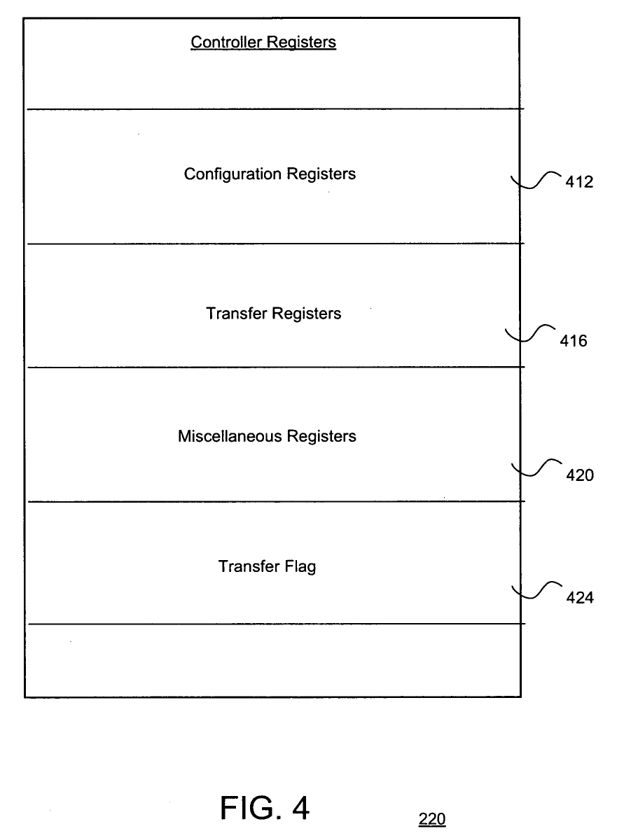

Referring now to FIG. 4, a block diagram for one embodiment of the FIG. 2 controller registers 220 is shown, in accordance with the present invention. In the FIG. 4 embodiment, controller registers 220 include, but are not limited to, configuration registers 412, transfer registers 416, miscellaneous registers 420, and a transfer flag 424. In alternate embodiments, controller registers 220 may include elements and functionalities in addition to, or instead of, certain of the elements and functionalities discussed in conjunction with the FIG. 4 embodiment.

In the FIG. 4 embodiment, CPU 122 (FIG. 1) or other appropriate entities may advantageously write information into controller registers 220 to specify various types of operational parameters and other relevant information for use by controller logic 212 of display controller 128. In the FIG. 4 embodiment, controller registers 220 may utilize configuration registers 412 for storing various types of information relating to the configuration of display controller 128 and/or display 134 of electronic device 110. For example, configuration registers 220 may specify a display type, a display size, a display frame rate, and various display timing parameters. In the FIG. 4 embodiment, controller registers 220 may utilize transfer registers 416 for storing various types of information relating to transfer operations for providing pixel data from video memory 216 (FIG. 3) to display 134 of electronic device 110.

In the FIG. 4 embodiment, controller registers 220 may utilize miscellaneous registers 420 for effectively storing any desired type of information or data for use by display controller 128. In the FIG. 4 embodiment, controller logic 212, write counter 228, transfer timer 232 (FIG. 2), or other appropriate entity may set a transfer flag 424 to indicate that certain conditions for triggering a frame transfer of image data to display 134 have been met. In response, a corresponding frame transfer procedure may be initiated by CPU 122 as discussed below in conjunction with FIGS. 6-9.

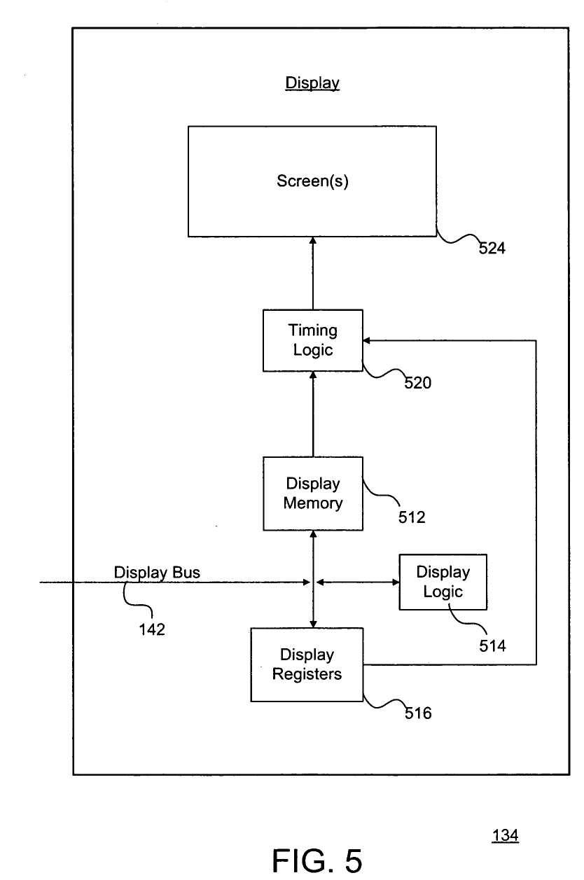

Referring now to FIG. 5, a block diagram for one embodiment of the FIG. 1 display 134 is shown, in accordance with the present invention. In the FIG. 5 embodiment, display 134 includes, but is not limited to, a display memory 512, display logic 514, display registers 516, timing logic 520, and one or more screen(s) 524. In alternate embodiments, display 134 may include elements and functionalities in addition to, or instead of, certain of the elements and functionalities discussed in conjunction with the FIG. 5 embodiment.

In the FIG. 5 embodiment, display 134 is implemented as a random-access-memory based liquid-crystal display panel (RAM-based LCD panel). However, in alternate embodiments, display 134 may be implemented by utilizing any type of appropriate display technologies or configurations. In the FIG. 5 embodiment, display controller 128 provides various types of display information to display registers 516 via display bus 142. Display registers 516 may then utilize the received display information for effectively controlling timing logic 520. In the FIG. 5 embodiment, display logic 514 manages and coordinates data transfer and display functions for display 134.

In the FIG. 5 embodiment, CPU 122 (FIG. 1) coordinates a manual frame transfer configuration procedure in which display controller 128 provides image data from video memory 216 (FIG. 2) to display memory 512 via display bus 142. In the FIG. 5 embodiment, display memory 512 is typically implemented as random-access memory (RAM). However, in various other embodiments, any effective types or configurations of memory devices may be utilized to implement display memory 512. In the FIG. 5 embodiment, display memory 512 then advantageously provides the image data received from display controller 128 to one or more screens 524 via timing logic 520 for viewing by a device user of electronic device 10. Various techniques for efficiently transferring image data to display 134 are further discussed below in conjunction with FIGS. 6 through 9.

Referring now to FIG. 6, a flowchart of method steps for performing a transfer cycle initialization procedure is shown, in accordance with one embodiment of the present invention. The flowcharts shown in FIGS. 6-9 together describe one embodiment for effectively utilizing the present invention. The FIG. 6 flowchart is presented for purposes of illustration, and in alternate embodiments, the present invention may utilize steps and sequences in addition to, or instead of, certain of the steps and sequences discussed in conjunction with the FIG. 6 embodiment.

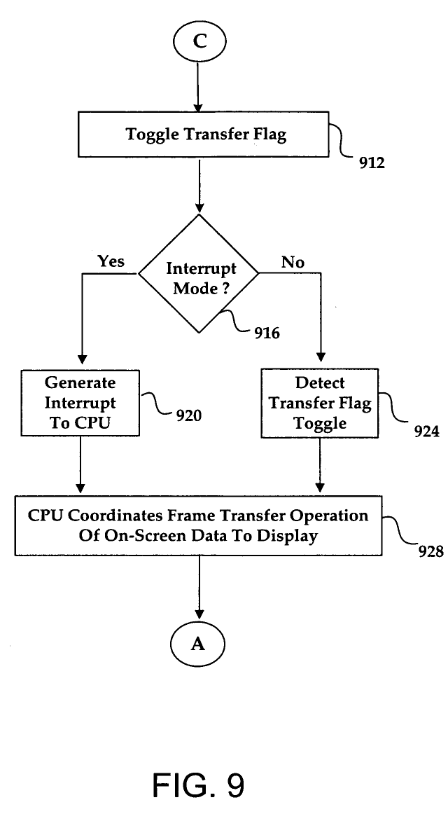

In the FIG. 6 embodiment, step 612 occurs at letter “A” which follows step 928 of FIG. 9. In step 612, CPU 122, display controller 128, or other appropriate entity defines one or more storage locations in video memory 216 (FIG. 2) for monitoring write operations to on-screen data 312 (FIG. 3). In step 616, CPU 122, display controller 128, or other appropriate entity selects a write threshold value for triggering manual frame transfer operations with write counter 228. In step 620, CPU 122, display controller 128, or other appropriate entity selects a transfer period for triggering manual frame transfer operations with transfer timer 232.

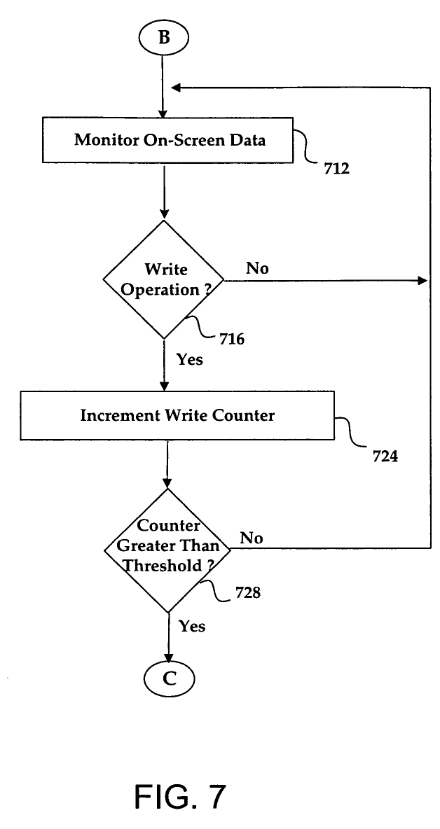

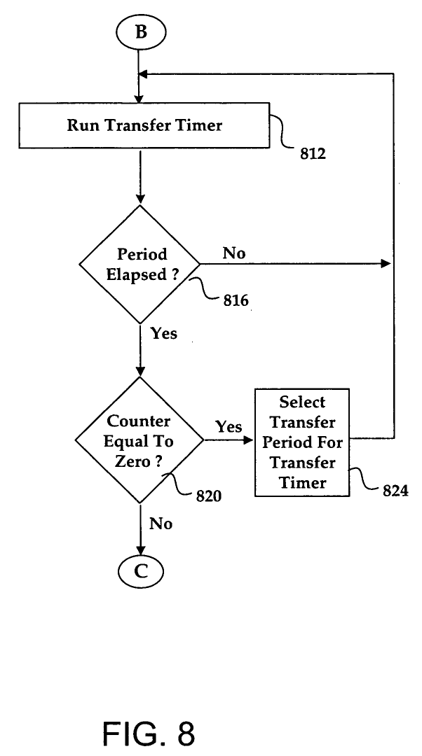

In step 624, CPU 122, display controller 128, or other appropriate entity determines whether to perform manual frame transfer operations in a transfer interrupt mode. If CPU 122, display controller 128, or other appropriate entity determines to function in a transfer interrupt mode, then in step 628, CPU 122, display controller 128, or other appropriate entity enables the transfer interrupt mode by utilizing any appropriate means. The FIG. 6 process may then advance to step 712 of FIG. 7 and to step 812 of FIG. 8 through connecting letter “B”.

Referring now to FIG. 7, a flowchart of method steps for utilizing a write counter 228 is shown, in accordance with one embodiment of the present invention. The flowcharts shown in FIGS. 6-9 together describe one embodiment for effectively utilizing the present invention. The FIG. 7 flowchart is presented for purposes of illustration, and in alternate embodiments, the present invention may utilize steps and sequences in addition to, or instead of, certain of the steps and sequences discussed in conjunction with the FIG. 7 embodiment.

In the FIG. 7 embodiment, step 712 occurs at letter “B” which follows step 628 of FIG. 6. In step 712, controller logic 212 initially monitors on-screen data 312 in video memory 212. In step 716, controller logic 212 determines whether a write operation to on-screen data 312 has occurred. If a write operation to on-screen data 312 has occurred, then in step 724, controller logic 212 increments write counter 228 by utilizing any effective means.

In step 728, controller logic 212 determines whether the current counter value of write counter 228 is greater than a pre-determined transfer threshold value. If the current counter value of write counter 228 is not greater than the pre-determined transfer threshold value, then the FIG. 7 process returns to step 712, and repeats the foregoing steps of the FIG. 7 embodiment. However, if the current counter value of write counter 228 is greater than the pre-determined transfer threshold value, then the FIG. 7 process advances through letter “C” to step 912 of FIG. 9.

Referring now to FIG. 8, a flowchart of method steps for utilizing a transfer timer 232 is shown, in accordance with one embodiment of the present invention. The flowcharts shown in FIGS. 6-9 together describe one embodiment for effectively utilizing the present invention. The FIG. 8 flowchart is presented for purposes of illustration, and in alternate embodiments, the present invention may utilize steps and sequences in addition to, or instead of, certain of the steps and sequences discussed in conjunction with the FIG. 8 embodiment.

In the FIG. 8 embodiment, step 812 occurs at letter “B” which follows step 628 of FIG. 6. In the FIG. 8 embodiment, in step 812, display controller 128 runs transfer timer 232 to measure a predetermined transfer period after which a full-frame transfer operation may be triggered if at least one write operation to on-screen data 312 has occurred. In step 816, controller logic 212 determines whether the foregoing pre-determined transfer period has elapsed by evaluating a current timer value from transfer timer 232. If the pre-determined transfer period has elapsed, then in step 820, controller logic 212 determines whether a current counter value from write counter 228 is equal to zero. If the current counter value of write counter 228 is equal to zero, then a transfer period may be selected for the transfer timer, and the FIG. 8 process may return to foregoing step 812. However, if the current counter value of write counter 228 is not equal to zero, then the FIG. 8 process advances through letter “C” to step 912 of FIG. 9.

Referring now to FIG. 9, a flowchart of method steps for performing a manual frame transfer operation is shown, in accordance with one embodiment of the present invention. The flowcharts shown in FIGS. 6-9 together describe one embodiment for effectively utilizing the present invention. The FIG. 9 flowchart is presented for purposes of illustration, and in alternate embodiments, the present invention may utilize steps and sequences in addition to, or instead of, certain of the steps and sequences discussed in conjunction with the FIG. 9 embodiment.

In the FIG. 9 embodiment, in step 912, controller logic 212 or other appropriate entity toggles a transfer flag 424 in controller registers 220 to indicate that a transfer trigger event has occurred. In the FIG. 9 embodiment, the transfer trigger event may be triggered in any appropriate manner. For example, either write counter 228 or transfer timer 232 may be utilized to provide the foregoing transfer trigger event.

In step 916, controller logic 212 determines whether a transfer interrupt mode is currently enabled for performing manual frame transfer operations. If controller logic 212 determines that the transfer interrupt mode is currently enabled, then in step 920, controller logic 212 generates a transfer interrupt to CPU 122 to indicate that the transfer trigger event has occurred. In response, in step 928, CPU 122 coordinates a full-frame transfer of the current on-screen data 312 from display controller 128 to display 134 (FIG. 1).

However, in step 916, if controller logic 212 determines that the transfer interrupt mode is not currently enabled, then in step 924, CPU 122 detects that transfer flag 424 has been toggled from a known previous state to a new current state. In certain embodiments, CPU 122 may periodically poll transfer flag 424 to determine whether a manual frame transfer operation is required, instead of controller logic 212 affirmatively sending the foregoing transfer interrupt as a notification to CPU 122. In response, in step 928, CPU 122 manually coordinates a full-frame transfer of the current on-screen data 312 from display controller 128 to display 134 (FIG. 1). The FIG. 9 process may then return to step 612 of FIG. 6 through connecting letter “A”. For at least the foregoing reasons, the present invention therefore provides an improved system and method for efficiently performing manual frame transfers of image data.

The invention has been explained above with reference to certain preferred embodiments. Other embodiments will be apparent to those skilled in the art in light of this disclosure. For example, the present invention may be implemented using certain configurations and techniques other than those described in the embodiments above. Additionally, the present invention may effectively be used in conjunction with systems other than those described above as the preferred embodiments. Therefore, these and other variations upon the foregoing embodiments are intended to be covered by the present invention, which is limited only by the appended claims.

What is claimed is:

1. A system for handling electronic information, comprising:
controller logic that toggles a transfer flag in response to a transfer trigger event that initiates a manual frame transfer operation of on-screen data from a video memory to a data destination, said transfer trigger event being alternately generated by a write counter or a transfer timer; and
managing means that coordinates said manual frame transfer operation in response to said transfer flag to thereby transfer said on-screen data from said video memory to said data destination.

2. The system of claim 1 wherein said controller logic is implemented in a display controller that performs said manual frame transfer operation under direction of said managing means, said managing means including a central processing unit.

3. The system of claim 2 wherein said display controller conserves device resources and operating power for a portable electronic device by transferring said on-screen data only when said transfer event occurs, said display controller being implemented as an integrated circuit device that functions as a transparent interface between said central processing unit and a display of said portable electronic device.

4. The system of claim 1 wherein said data destination includes a display for a portable electronic device, said display being implemented as a random-access-memory based liquid-crystal display.

5. The system of claim 4 wherein said portable electronic device is implemented as a portable cellular telephone device.

6. The system of claim 1 wherein performing said manual frame transfer operation for said on-screen data conserves system resources and operating power for a portable host electronic device because said manual frame transfer operation is performed only when said transfer flag is toggled to indicate that said transfer event has occurred.

7. The system of claim 1 wherein said controller logic toggles said transfer flag in response to said transfer trigger event that is alternately generated by a transfer timer trigger that occurs after a pre-determined transfer period has been exceeded, or a write counter trigger that indicates that a total written pixel value has exceeded a pre-determined write-operation pixel threshold.

8. The system of claim 1 wherein said controller logic performs a frame transfer initialization procedure that includes defining a write operation threshold for said write counter.

9. The system of claim 1 wherein said controller logic performs a frame transfer initialization procedure that includes defining a frame transfer period for said transfer timer.

10. The system of claim 1 wherein said controller logic performs a frame transfer initialization procedure that includes defining one or more memory locations in said video memory for monitoring write operations to said on-screen data, said frame transfer initialization procedure also including enabling or disabling a transfer interrupt mode.

11. The system of claim 1 wherein said controller logic initially resets said write counter to an initialized counter value, said controller logic then incrementing said write counter whenever a write operation to said on-screen data occurs.

12. The system of claim 11 wherein said controller logic determines that a current counter value of said write counter is greater than a pre-determined counter threshold value, said controller logic then responsively toggling said transfer flag.

13. The system of claim 1 wherein said controller logic initially resets said transfer timer to an initialized timer value, said controller logic then running said transfer timer to measure a pre-determined transfer period, said controller logic toggling said transfer flag when said pre-determined transfer period has elapsed.

14. The system of claim 13 wherein said controller logic toggles said transfer flag when said pre-determined transfer period has elapsed and at least one write operation to said on-screen data has occurred.

15. The system of claim 1 wherein said controller logic toggles said transfer flag to indicate that said transfer trigger event from either said write counter or said transfer timer has occurred.

16. The system of claim 15 wherein said controller logic and said managing means determine that said transfer flag has been toggled by comparing a current transfer flag state with a known previous transfer flag state.

17. The system of claim 15 wherein said controller logic actively sends a transfer interrupt to said managing means as a notification that said transfer trigger event has occurred.

18. The system of claim 15 wherein said managing means periodically polls said transfer flag to determine whether said transfer trigger event has occurred.

19. The system of claim 15 wherein said managing means instructs said controller logic to transfer said on-screen data to display logic of said data destination.

20. The system of claim 19 wherein said display logic writes said on-screen data into a specific local storage location, said display logic then providing said on-screen data from said specific local storage location to a screen of said data destination for displaying to a device user.

21. A method for handling electronic information, comprising the steps of:
toggling a transfer flag with controller logic in response to a transfer trigger event that initiates a manual frame transfer operation of on-screen data from a video memory to a data destination, said transfer trigger event being alternately generated by a write counter or a transfer timer; and
utilizing managing means to coordinate said manual frame transfer operation in response to said transfer flag to thereby transfer said on-screen data from said video memory to said data destination.

22. The method of claim 21 wherein said controller logic is implemented in a display controller that performs said manual frame transfer operation under direction of said managing means, said managing means including a central processing unit.

23. The method of claim 22 wherein said display controller conserves device resources and operating power for a portable electronic device by transferring said on-screen data only when said transfer event occurs, said display controller being implemented as an integrated circuit device that functions as a transparent interface between said central processing unit and a display of said portable electronic device.

24. The method of claim 21 wherein said data destination includes a display for a portable electronic device, said display being implemented as a random-access-memory based liquid-crystal display.

25. The method of claim 24 wherein said portable electronic device is implemented as a portable cellular telephone device.

26. The method of claim 21 wherein performing said manual frame transfer operation for said on-screen data conserves system resources and operating power for a portable host electronic device because said manual frame transfer operation is performed only when said transfer flag is toggled to indicate that said transfer event has occurred.

27. The method of claim 21 wherein said controller logic toggles said transfer flag in response to said transfer trigger event that is alternately generated by a transfer timer trigger that occurs after a pre-determined transfer period has been exceeded, or a write counter trigger that indicates that a total written pixel value has exceeded a pre-determined write-operation pixel threshold.

28. The method of claim 21 wherein said controller logic performs a frame transfer initialization procedure that includes defining a write operation threshold for said write counter.

29. The method of claim 21 wherein said controller logic performs a frame transfer initialization procedure that includes defining a frame transfer period for said transfer timer.

30. The method of claim 21 wherein said controller logic performs a frame transfer initialization procedure that includes defining one or more memory locations in said video memory for monitoring write operations to said on-screen data, said frame transfer initialization procedure also including enabling or disabling a transfer interrupt mode.

31. The method of claim 21 wherein said controller logic initially resets said write counter to an initialized counter value, said controller logic then incrementing said write counter whenever a write operation to said on-screen data occurs.

32. The method of claim 31 wherein said controller logic determines that a current counter value of said write counter is greater than a pre-determined counter threshold value, said controller logic then responsively toggling said transfer flag.

33. The method of claim 21 wherein said controller logic initially resets said transfer timer to an initialized timer value, said controller logic then running said transfer timer to measure a pre-determined transfer period, said controller logic toggling said transfer flag when said pre-determined transfer period has elapsed.

34. The method of claim 33 wherein said controller logic toggles said transfer flag when said pre-determined transfer period has elapsed and at least one write operation to said on-screen data has occurred.

35. The method of claim 21 wherein said controller logic toggles said transfer flag to indicate that said transfer trigger event from either said write counter or said transfer timer has occurred.

36. The method of claim 35 wherein said controller logic and said managing means determine that said transfer flag has been toggled by comparing a current transfer flag state with a known previous transfer flag state.

37. The method of claim 35 wherein said controller logic actively sends a transfer interrupt to said managing means as a notification that said transfer trigger event has occurred.

38. The method of claim 35 wherein said managing means periodically polls said transfer flag to determine whether said transfer trigger event has occurred.

39. The method of claim 35 wherein said managing means instructs said controller logic to transfer said on-screen data to display logic of said data destination.

40. The method of claim 39 wherein said display logic writes said on-screen data into a specific local storage location, said display logic then providing said on-screen data from said specific local storage location to a screen of said data destination for displaying to a device user.

41. A system for handling electronic information, comprising:
means for toggling a transfer flag in response to a transfer trigger event that initiates a manual frame transfer operation of on-screen data from a video memory to a data destination, said transfer trigger event being alternately generated by a write counter or a transfer timer; and
means for coordinating said manual frame transfer operation in response to said transfer flag to thereby transfer said on-screen data from said video memory to said data destination.

42. A system for handling electronic information, comprising:
on-screen data stored in a video memory device; and
controller logic that detects a transfer trigger event, said controller logic responsively initiating a manual frame transfer operation for said on-screen data from said video memory to a data destination.
